(19) United States
(12) Patent Application Publication
(10) Pub. No.: US 2025/0284468 A1
(43) Pub. Date: Sep. 11, 2025

(54) TECHNIQUES FOR SUPPORTING CONTENT CREATION IN DEVELOPER ENVIRONMENTS

(71) Applicant: Red Hat, Inc., Raleigh, NC (US)

(72) Inventors: Ganesh Balasaheb NALAWADE, New Delhi (IN); Priyam SAHOO, New Delhi (IN)

(21) Appl. No.: 18/595,855

(22) Filed: Mar. 5, 2024

(51) Int. Cl. G06F 8/33

(52) U.S. Cl. CPC G06F 8/33

(57) ABSTRACT

A file system of a workspace including a playbook may be monitored. A modification to the files system of the workspace may be detected. A path corresponding to the modification to the file system of the workspace may be injected, by a processing device, into a current configuration associated with the playbook to produce an updated configuration associated with the playbook. A language server may be triggered to reinitialize based on the updated configuration associated with the playbook.

### TECHNICAL FIELD

Aspects of the present disclosure relate to techniques for supporting content creation in developer environments and, more particularly, to supporting content creation in development environments for information technology (IT) automation.

### BACKGROUND

Information technology (IT) includes a set of related fields that encompass computer systems, software, programming languages, and information processing and storage. IT automation, sometimes referred to as infrastructure automation, refers to the use of technology that performs tasks with reduced human assistance in order to control the hardware, software, networking components, operating system, and data storage components used to deliver information technology services and solutions. Typically, IT automation includes the use of software to create repeatable instructions and processes to replace or reduce human interaction with IT systems. Automation software works within the confines of those instructions, tools, and frameworks to carry out tasks with little to no human intervention. Automation can integrate with and apply to anything from network automation to infrastructure, cloud provisioning, standard operating environments, application deployment, and configuration management.

An integrated development environment (IDE) refers to a software application that facilitates software development, such as for IT automation. An IDE is typically designed to maximize programmer productivity by providing tight-knit components with similar user interfaces. Additionally, an IDE may provide various features to improve programmer productivity including features for authoring, modifying, compiling, deploying, and/or debugging software. For example, one feature may continuously parse code while it is being edited, providing immediate feedback when syntax errors are introduced, thus allowing developers to debug code in an easier and quicker manner.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

To easily identify the discussion of any particular element or act, the most significant digit or digits in a reference number refer to the figure number in which that element is first introduced.

FIG. 1 illustrates an exemplary operating environment of an extension for supporting content creation in developer environments, according to some embodiments of the present disclosure.

FIG. 2A illustrates various aspects of a file system, according to some embodiments of the present disclosure.

FIG. 2B illustrates various aspects of a code editor interface, according to some embodiments of the present disclosure.

FIGS. 3A and 3B illustrate an exemplary process flow for supporting content creation in developer environments, according to some embodiments of the present disclosure.

FIG. 4 illustrates a flow diagram of a method for supporting language features in developer environments, according to some embodiments of the present disclosure.

FIG. 5 illustrates a block diagram of an example system for supporting language features in developer environments, according to some embodiments of the present disclosure.

FIG. 6 illustrates a block diagram of an example system, according to some embodiments of the present disclosure.

### DETAILED DESCRIPTION

The following description sets forth numerous specific details such as examples of specific systems, components, methods, and so forth, in order to provide a good understanding of various embodiments of the techniques described herein for supporting content creation in development environments for IT automation. It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

IT automation provides capabilities like configuration management, software provisioning, deployment, and orchestration. To perform these automation activities, a developer needs to create content (e.g., write code), such as playbooks and roles, in a developer environment (e.g., code editors, integrated development environments (IDE), etc.). Oftentimes, the content may be created using multiple programming languages, such as Ansible™ and Python™. However, each language can have its own syntax, semantics, and best practices, which can be difficult for developers to learn. These difficulties are exacerbated when dependable, real-time support is unavailable in developer environments. Further, best practices are continually evolving and without dependable, real-time support it can be impractical to adhere to the best practices. These limitations can drastically reduce the efficiency of software developers, the quality of the created content, and the functionality of developer environments, contributing to excessive resources demands to create content, poorly performing content, and systems, devices, and techniques with limited capabilities.

Accordingly, many embodiments disclosed hereby provide various components to support features that enable the efficient creation of quality IT automation content in development environments. More specifically, various embodiments may provide at least one of creation feature support components, language server (LS) feature support components, artificial intelligence (AI) feature support components, or playbook adjacent feature support components. In several embodiments, these features may be implemented via a developer environment extension. The creation feature support components may operate to automate many aspects of creating and scaffolding collections. The LS feature support components may operate to provide various language features, such as go to definition, hover, autocompletion, and validation, during content creation. The AI feature support components may operate to provide various AI features, such as code generation and task recommendations. The playbook adjacent feature support components may operate to enable language and/or AI features based on content in playbook adjacent files. For example, the playbook adjacent feature support components may monitor changes to a file system of a workspace including a playbook. Further, in response to detecting a change including the addition of a new collection to the workspace, the playbook adjacent feature support components may automatically update a corresponding configuration to include a path of the new collection and cause a language server to reinitialize based on the updated configuration. This reinitialization based on the updated configuration enables the language server to provide language features based on the content of the new collection, such as by providing autocompletion suggestions including a function defined in the new collection.

In these and other ways, components/techniques described hereby may provide many technical advantages, such as the development of reliable content that adheres to best practices in a quicker and more efficient manner. For example, language features and/or AI features can be automatically provided in real-time with respect to playbook adjacent files. In another example, the creation and scaffolding of new collections can be simplified to a few inputs that do not require expert knowledge. In yet another example, AI can be utilized to provide code and task recommendations to improve speed and reduce errors in content creation. In yet another example, relevant and useful information to assist in content creation can readily be identified and surfaced to users. Thus, the computer-based techniques of the current disclosure improve the functioning of developer environments for IT automation, resulting in better user experiences and improved content for IT automation as compared to conventional approaches. Further, embodiments disclosed hereby can be practically utilized to improve the functioning of a computer and/or to improve a variety of technical fields including IT automation, developer environments, and content creation.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

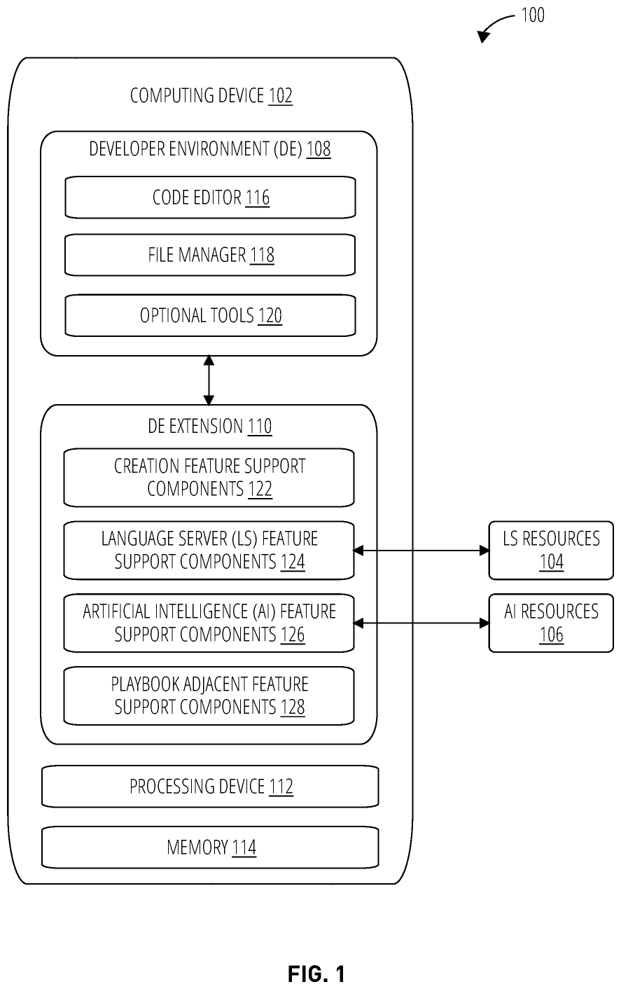

FIG. 1 illustrates an operating environment 100 of an extension for supporting content creation in developer environments according to some embodiments. Operating environment 100 includes a computing device 102 communicatively coupled to one or more language server (LS) resources 104 and one or more artificial intelligence (AI) resources 106. The computing device 102 includes a developer environment (DE) 108, a DE extension 110, a processing device 112, and a memory 114. The DE 108 may include a code editor 116, a file manager 118, and one or more optional tools 120. In various embodiments, the DE extension 110 may operate to provide the DE 108 with advantageous and reliable features to improve content creation in DE 108. In the illustrated embodiment, the DE extension 110 includes one or more creation feature support components 122, one or more LS feature support components 124, one or more AI feature support components 126, and one or more playbook adjacent feature support components 128. One or more components of FIG. 1 may be the same or similar to one or more other components disclosed hereby. Further, aspects discussed with respect to various components in FIG. 1 may be implemented by one or more other components from one or more other embodiments without departing from the scope of this disclosure. For example, one or more of the LS resources 104 and/or AI resources 106 may be included in computing device 102 without departing from the scope of this disclosure. Embodiments are not limited in this context.

Several embodiments described hereby may provide an integrated approach for language support, content scaffolding tools, and AI services in DE 108 using DE extension 110. In several such embodiments, the integrated approach may utilize Language Server Protocol (LSP). This integrated approach can facilitate fast and efficient playbook and content development (e.g., Ansible™ content). Further, this integrated approach can promote the adoption of best practices within the community, such as by providing recommendations and suggestions that adhere to best practices. By leveraging the new and useful techniques described hereby, developers can ensure the implementation of standardized and optimized approaches, leading to higher quality and more reliable content. To ease the processes of developing content and helping write better content faster, many embodiments utilize LSP to provide Ansible™ language support including at least one of generative AI for code recommendations, advanced validations, autocompletion, or go to definition.

More generally, the DE 108 may operate to enables users to develop content for IT automation and DE extension 110 may be installed to provide new and useful features to the DE 108. The code editor 116 of DE 108 may provide a window for a user to view and modify content files. The code editor 116 may provide robust syntax highlighting regarding indentations, keyword and variable recognitions, and module name identifications, empowering users to detect syntactical errors in real-time. This feature can enhance the development experience by allowing users to identify and resolve issues on the go, minimizing problems during the execution of workflows (e.g., Ansible™ workflows). The file manager 118 may manage these files such as by creating file systems and workspaces, importing/exporting files, and storing/retrieving files. In some embodiments, the file manager 118 may maintain configuration information associated with one or more of the file systems, files, workspaces, playbooks, projects, and the like. In various embodiments, the file manager 118 may enable users to view, open, and/or modify attributes and properties the files, file system, workspaces, etc. For example, file manager 118 may provide an interface that displays a workspace and enables a user to select a file in the workspace to open. In response to selection of a file to open, the file manager 118 may cause the file to be opened and displayed in the code editor 116. Additionally, DE 108 may include one or more optional tools, such as a creator tool or a linting tool.

In many embodiments, the additional features and/or functionalities supporting these features that enable the more efficient creation of better quality IT automation content in DE 108 may be provided, at least in part, by DE extension 110. In some embodiments, DE 108 may include a Visual Studio™ code (VSCode) environment and DE extension 110 may include a VSCode extension. As previously mentioned, DE extension 110 may provide, or support, at least one of creation features, language server features, artificial intelligence features, or playbook adjacent features. More specifically, the creation feature support components 122 may operate to automate many aspects of creating and scaffolding collections. For example, creation feature support components 122 may include a WebView™ application programming interface (API) to employ an interactive form to gather inputs associated with creating new files, such as a collection. The creation feature support components 122 may utilize the received data to generate an entire project structure and essential boilerplate code required for the efficient development of content collections. In various embodiments, integration of the WebView™ panel can enable seamless user interaction within the DE 108, promoting a streamlined and productive workflow for extending the IT automation capabilities using content collections (e.g., Ansible™ content collections).

In some embodiments, in response to opening the WebView™ to create a new collection, the creation feature support components 122 may perform one or more system requirement checks, such as various versions, locations, and/or tools may be checked. For example, it may be determined whether a creator tool is installed (e.g., as one of optional tools 120). If it is not installed, the creation feature support components 122 may cause it to be installed. In another example, Ansible™ and/or Python™ versions and locations may be checked. Next, the user may provide one or more input, such as namespace name, collection name, and init path. Additionally, one or more command line interface (CLI) and/or logging options may be provided. Once the inputs are provided and the collection is created, the collection may be added to the workspace. As described elsewhere, such as with respect to playbook adjacent feature support components 128, adding the collection to the workspace triggers reinitialization the language server having the scaffolded collection in the configuration, which means that all the language features are available for the new collection. Additionally, if logging is enabled, the output may be logged to a file and/or presented in the console.

The playbook adjacent feature support components 128 may operate to enable language and/or AI features based on content in playbook adjacent files. For example, the playbook adjacent feature support components may monitor changes to a file system of a workspace including a playbook. Further, in response to detecting a change including the addition of a new collection to the workspace (e.g., one created using creation feature support components 122), the playbook adjacent feature support components may automatically update a corresponding configuration to include a path of the new collection and cause a language server to reinitialize based on the updated configuration. This reinitialization based on the updated configuration enables the language server to provide language features based on the content of the new collection, such as by providing autocompletion suggestions including a function defined in the new collection. In various embodiments, the playbook adjacent feature support components 128 may determine actual plugins that are installed on a developer machine. In various such embodiments, the actual plugins that are installed on a developer machine may include one or more of the optional tools 120.

The LS feature support components 124 may operate to provide various language features during content creation, such as validation, autocompletion, hover, and go to definition. Validation may refer to a process for checking that code is correct. As a user develops content within the DE 108, a JSON remote procedure call (RPC) notification request may be sent (e.g., by playbook adjacent feature support components 128) to the language server. In various embodiments, the JSON RPC notification request may generally have the form: “Notification: textDocument/didOpen; Params: document” or “Notification: textDocument/didChange; Params: {documentURI, changes}”. In some embodiments, the language server may be running as a daemon process in the developer environment. The language server may, in turn, validate the file that the user is currently editing in the editor, such as by invoking tools like Ansible-lint, and provide diagnostics information to the DE 108 as a JSON RPC notification response. In various embodiments, a JSON RPC notification response may generally have the form: “Notification: textDocument/publishDiagnostics; Params: Dagnostic []”. The DE 108 may display this information, such as in a problems tab, to identify and communicate real-time problems in the code as the user develops it.

Autocompletion may refer to a feature in which the rest of a word that a user is typing is predicted and provided to the user as a suggestion. In various embodiments, when a user opens up an existing project within the DE 108 or creates a new one, the configuration or information about the project structure and workspace may be passed by the DE 108 (e.g., using one or more LS feature support components 124 in DE extension 110) to a language server in LS resources 104. The language server may then crawl the file system in possible locations where the core engine, collections, and/or roles are installed to fetch plugin documentation. The language server may parse the documentation and store it in a structured format in memory. This may be performed when the language server is initialized or reinitialized, such as in response to a change in the workspace (e.g., installation of a new collection).

As the user is developing the content, the DE 108 may trigger an autocompletion, which results in an autocompletion JSON RPC request to the language server. For example, an autocompletion may be triggered in response to a user typing two or more characters in the code editor 116. The request may include payload information like the file contents and the cursor position. The language server may utilize this information to identify the context in which the cursor is (e.g., play level, task level, etc.). If the cursor is in the context of the task, the language server parses the structured plugin data and identifies the possible completions for task names. If the cursor is within the context of the task, the language server may determine possible, or likely, completions for task arguments. If the cursor is at play level, the language server may determine possible, or likely, completions for keywords. These identified possible completions are passed to the DE 108 as a JSON-RPC response, and the DE 108, in turn, renders the possible completions (i.e., suggestions) in the code editor 116 from which the user can select one. In various embodiments, an autocompletion JSON RPC request may generally have the form: “Request: textDocument/completion; Params: {document, position}”. Similarly, an autocompletion JSON RPC response may generally have the form: “Response: textDocument/completion; Params: CompletionItems []”. In various embodiments, autocompletion may be provided for variables within playbooks, such as when working with Jinja inline brackets. In various such embodiments, the language server may dynamically suggest relevant variables by analyzing the level scopes, ensuring accurate and context-aware autocompletion support.

Hover may refer to a feature that presents addition information based on a position of the cursor. For example, if the cursor hovers over a word, additional information including the definition of the words may be presented, such as in a pop-up box. When a cursor is hovered over various elements (e.g., specific playbook elements), a factual description of the element may be presented. In response to hovering over variables, modules, or keywords, DE 108 is able to quickly identify and surface relevant contextual information, including documentation and data types, to facilitate a better understanding. In some embodiments, links to access corresponding files and/or additional information may be presented. Similar to other described features, the hover feature may utilize JSON RPC requests and responses. In various embodiments, a hover JSON RPC request may generally have the form: “Request: textDocument/hover; Params: {document, position}” and a hover JSON RPC response may generally have the form: “Response: textDocument/hover; Params: Hover”.

Go to definition may refer to a feature that provides go to type/interface definition support for a symbol or element selected in text of a file. With go to definition functionality, users can conveniently navigate through playbooks and the source code of the module written in Python. When the user selects a specific playbook element and triggers the go-to definition action, the DE 108 seamlessly jumps to the corresponding location where the code for the element is defined, such as in a playbook adjacent file). This feature facilitates module code exploration and promotes code reusability for content creation. Similar to other described features, the go to definition feature may utilize JSON RPC requests and responses. In various embodiments, a hover JSON RPC request may generally have the form: “Request: textDocument/definition; Params: {document, position}” and a go to definition JSON RPC response may generally have the form: “Response: textDocument/definition; Params: Location”.

The AI feature support components 126 may operate to provide various AI features, such as code generation and task recommendations. In various embodiments, the AI features may utilize generative AI. By integrating generative AI-based backend services to produce playbook task suggestions, the process of creating effective playbooks is simplified. The AI resources 106 may analyze relevant data, identify patterns, and generate intelligent recommendations for tasks to include in a playbook. This automation can save time and effort for users because they can rely on the AI analysis to provide valuable suggestions, making the playbook creation process easier and more efficient. In various embodiments, user interactions may be captured for the recommendations provided in the editor. For example, whether the user accepts or rejects suggestions may be tracked, such as by AI feature support components 126, and sent as telemetry data to the backend AI service (e.g., AI resources 106). The backend AI service may then utilize this information to improve the generative AI model performance in future suggestions. In some embodiments, information regarding the possible original source of a suggestion (e.g., training matches) may be presented to the user, such as in a WebView™ panel. This can ensure transparency and/or enable users to make informed decisions on whether to accept or reject the suggestion.

It should be noted that although a single processing device 112 and a single memory 114 is depicted in FIG. 1 for simplicity, other embodiments may include multiple processing devices, storage devices, or devices. Processing device 112 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 112 may also include one or more special-purpose processing devices such as an application specific integrated circuit (ASIC), a field programmable gate array (FPGA), a digital signal processor (DSP), network processor, or the like. Further details regarding generation of energy usage estimates 122 will be discussed below.

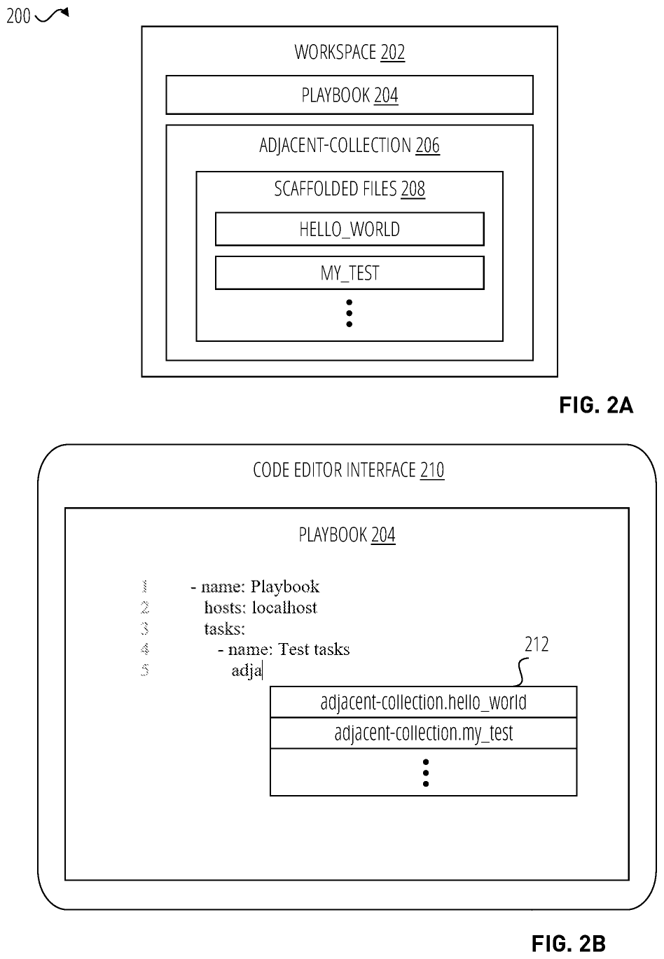

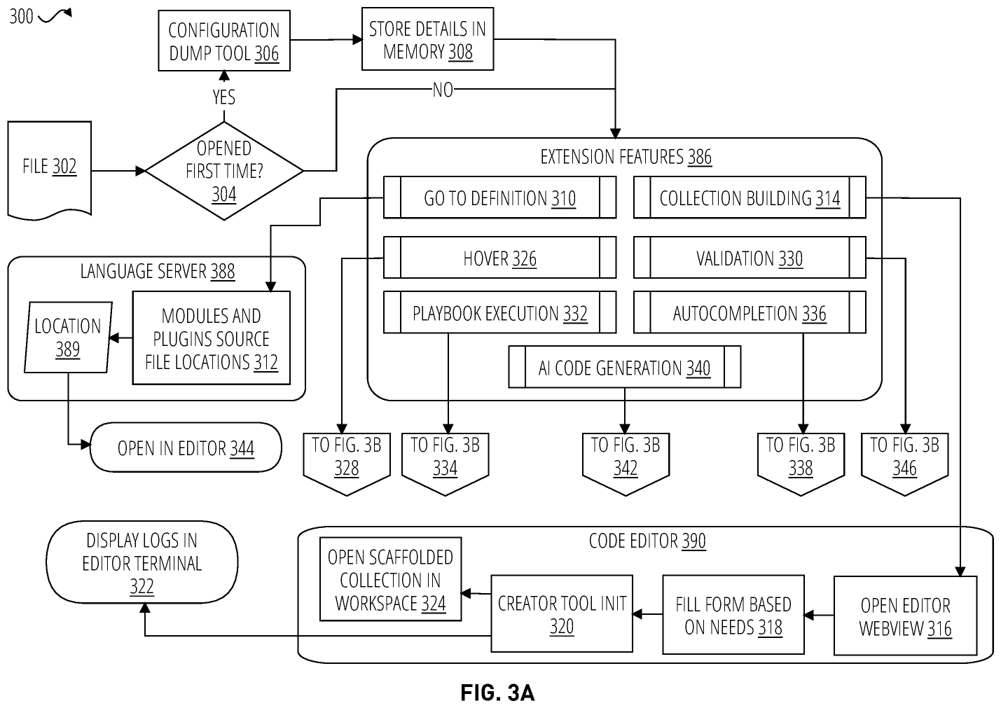

FIG. 2A illustrates various aspects of a file system 200 according to some embodiments. In the illustrated embodiment, the file system 200 includes a workspace 202 with a playbook 204 and an adjacent-collection 206. The adjacent-collection 206 may include one or more scaffolded files 208, such as a HELLO_WORLD file and a MY_TEST file. The scaffolded files 208 may be created automatically (e.g., via creation feature support components 122) and/or manually. Further, files automatically created may still be edited manually. In various embodiments, the workspace 202 may be monitored, such as by one of the playbook adjacent feature support components 128, to determine when changes are made to the file system 200. In various embodiments, changes to the file system 200 may be utilized to trigger configuration updates and/or reinitialization of a language server or AI server. One or more components of FIG. 2A may be the same or similar to one or more other components disclosed hereby. Further, aspects discussed with respect to various components in FIG. 2A may be implemented by one or more other components from one or more other embodiments without departing from the scope of this disclosure. For example, the file system 200 may be implemented by file manager 118 without departing from the scope of this disclosure. Embodiments are not limited in this context.

FIG. 2B illustrates various aspects of a code editor interface 210 according to some embodiments. In the illustrated embodiment, the code editor interface 210 displays exemplary contents of the playbook 204 along with one or more autocompletion suggestions 212. In various embodiments, the techniques described hereby may enable the autocompletion suggestions 212 to be based on content of files in playbook adjacent files (e.g., adjacent-collection 206). For example, HELLO_WORLD and MY_TEST from adjacent-collection 206 of workspace 202 may be presented in suggestions 212 in response to a user typing “adja” because “adjacent-collection” is included in their path. Further, a user may simply click on one of the suggestions to complete “adja”. One or more components of FIG. 2B may be the same or similar to one or more other components disclosed hereby. Further, aspects discussed with respect to various components in FIG. 2B may be implemented by one or more other components from one or more other embodiments without departing from the scope of this disclosure. For example, the code editor interface 210 may be implemented by code editor 116 without departing from the scope of this disclosure. In another example, the suggestions 212 may be implemented by AI feature support components 126 and/or LS resources 104 without departing from the scope of this disclosure. Embodiments are not limited in this context.

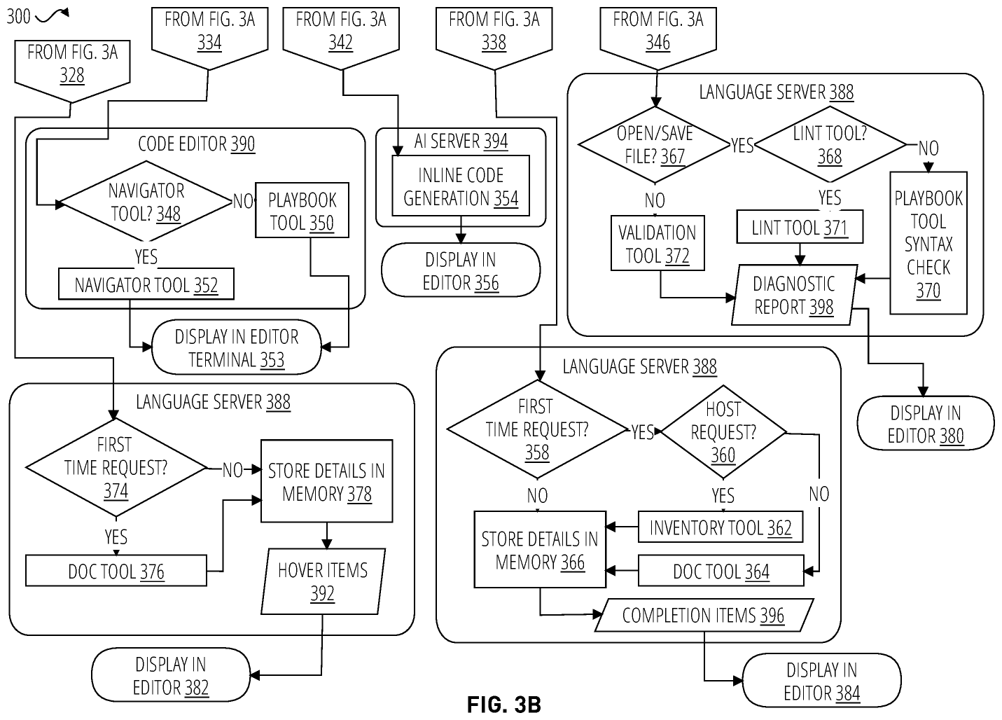

FIGS. 3A and 3B illustrate a process flow 300 for supporting content creation in developer environments according to some embodiments. For example, process flow 300 may support content creation by providing features, such as go to definition, collection building, hover, validation, playbook execution, and AI code generation, in a developer environment. One or more components of FIGS. 3A and 3B may be the same or similar to one or more other components disclosed hereby. For example, file 302 may be the same or similar to one or more files in adjacent-collection 206. In another example, language server 388 may be the same or similar to LS resources 104. In yet another example, code editor 390 may be the same or similar to code editor 116. Further, aspects discussed with respect to various components in FIGS. 3A and 3B may be implemented by one or more other components from one or more other embodiments without departing from the scope of this disclosure. Embodiments are not limited in this context.

Referring to FIG. 3A, the process flow 300 begins with the opening of file 302. At decision block 304 it is determined if it is the first time file 302 has been opened. If it is the first time, the process flow 300 proceeds to block 306 where a configuration dump tool is utilized and the details are stored in memory at block 308. However, if it is not the first time file 302 has been opened, process flow 300 proceeds to extension features 386. The extension features 386 include various subroutines associated with various features described hereby. Each of these subroutines will now be described in more detail. It will be appreciated that each of these subroutines may be performed as part of supporting the corresponding feature and the various subroutines are only performed when one of the features is requested (e.g., via JSON RPC requests).

Subroutine block 310 may correspond to the go to definition feature. When the go to definition feature is performed (such as in response to a JSON RPC request), the language server 388 may utilize the source file locations of modules and plugins to determine the location of the requested definition. This location may then be opened, or presented, in the editor at block 344. It will be appreciated that the location may be received from the language server 388 in a JSON RPC response.

Subroutine block 314 may correspond to the collection building feature. When the collection building feature is performed, the editor WebView™ may be opened in the code editor 390. Next, the form may be completed (e.g., namespace name, collection name, init path, log option, etc.) based on the user needs at block 318. Once the inputs are received, a creator tool init may be utilized to create and scaffold the collection at block 320. The scaffolded collection may then be opened in the workspace at block 324. Additionally, when the log option is enabled, the logs may be displayed in the editor terminal at block 322.

Subroutine block 326 may correspond to the hover feature. When the hover feature is performed (such as in response to a JSON RPC request), the language server 388 may determine whether it is a first time request at decision block 374. If it is a first time request, a doc tool is utilized at block 376 and the details are stored in memory at block 378. However, if it is not a first time request, the details are stored in memory at block 378. Next, the hover items 392 may be determined and displayed in the editor at block 382. It will be appreciated that the hover items 392 may be received from the language server 388 in a JSON RPC response.

Subroutine block 332 may correspond to the playbook execution feature. When the playbook execution feature is performed, the code editor 390 may determine if a navigator tool is installed at decision block 348. If the navigator tool is installed, it may be called at block 352 and the results may be displayed in the editor terminal at block 353. If the navigator tool is not installed, a playbook tool may be called at block 350 and the results may be displayed in the editor terminal. In various embodiments, a JSON RPC associated with the playbook execution feature may generally have the form: “ExecutePlaybook; Params: {document, method}”. Subroutine block 340 may correspond to the AI code generation feature. When the AI code generation feature is performed, the AI server 394 may perform inline code generation at block 354 and the results may be displayed in the editor.

Subroutine block 336 may correspond to the autocompletion feature. When the autocompletion feature is performed (such as in response to a JSON RPC request), the language server 388 may determine if it is the first time requested at decision block 358. If it is not a first time request, the details may be stored in memory at block 366. If it is a first time request, it may be determined whether it is a host request at decision block 360. If it is a host request, an inventor tool may be called at block 362 and the results may be stored in memory at block 366. If it is not a host request, a doc tool may be called at block 364 and the results may be stored in memory at block 366. The completion items 396 may then be displayed in the editor at block 384. It will be appreciated that the completion items 396 may be received from the language server 388 in a JSON RPC response.

Subroutine block 330 may correspond to the validation feature. When the validation feature is performed (such as in response to a JSON RPC request), the language server 388 may determine if it is an open/save file at decision block 367. If it is not, a validation tool may be called at block 372. If it is an open/save file, then it may be determined if a lint tool is installed at decision block 368. If the lint tool is installed, the lint tool may be called at block 371. If the lint tool is not installed a playbook tool syntax check may be performed at block 370. The resulting diagnostic report 398 may then be displayed in the editor at block 380. It will be appreciated that the diagnostic report 398 may be received from the language server 388 in a JSON RPC response.

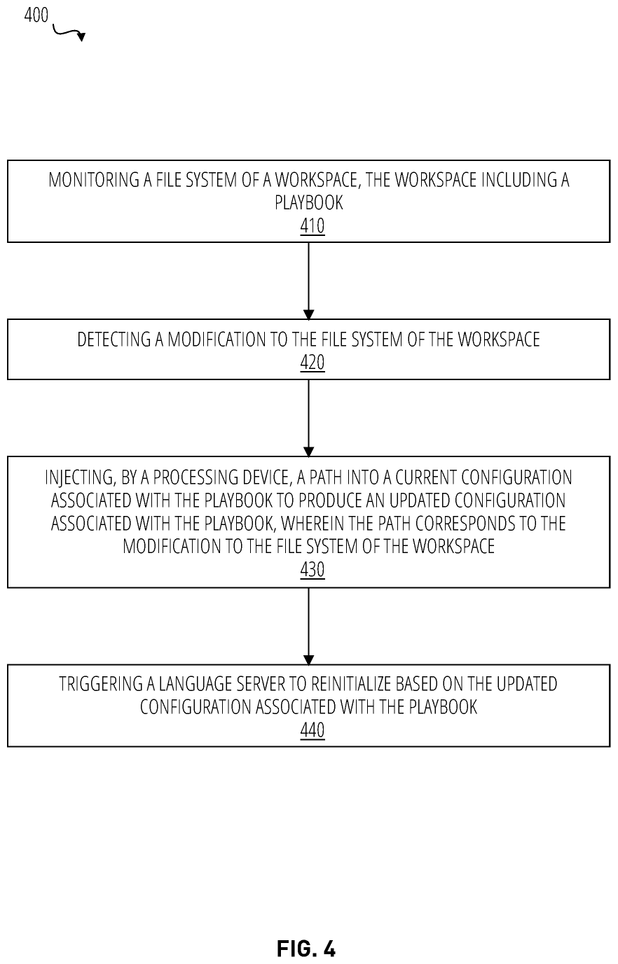

FIG. 4 is a flow diagram of a method 400 of supporting language features in developer environments according to some embodiments. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed through the execution of DE extension 110 by processing device 112 of FIG. 1.

With reference to FIG. 1, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where the processing logic monitors a file system of a workspace that includes a playbook. For example, LS feature support components 124 may monitor file system 200 including playbook 204. In some embodiments, LS feature support components 124 may include a file watcher that monitors file system 200 for changes. At block 420, the processing logic detects a modification to the file system of the workspace. For example, LS feature support components 124 may detect a modification to the file system 200 of playbook 204. In various embodiments, the modification may include the addition of one or more playbook adjacent files to the workspace, such as a playbook adjacent collection.

At block 430, the processing logic injects a path into a current configuration associated with the playbook to produce an updated configuration associated with the playbook. The path may correspond to the modification to the file system of the workspace. For example, the path may be injected into the file stored in memory in response to operation of a configuration dump tool (see e.g., block 306 and block 308 of process flow 300). In some embodiments, the configuration may be updated by LS feature support components 124 in DE extension 110 communicating the path to file manager 118 of DE 108. In some such embodiments, the DE extension 110 may cause the file manager 118 to inject the path into a configuration associated with the playbook.

At block 440, the processing logic triggers a language server to reinitialize based on the updated configuration associated with the playbook. For example, LS feature support components 124 may trigger a language server in LS resources 104 to reinitialize based on the updated configuration. In various embodiments, the updated configuration may be communicated to the language server. The reinitialization process based on the updated configuration may enable support for language features based on content corresponding to the modification of the file system. For example, if the modification includes the addition of a definition to a file, a go to definition feature provided by DE extension 110 may take a user to, or display, the definition in the file by interacting with the corresponding word in the playbook.

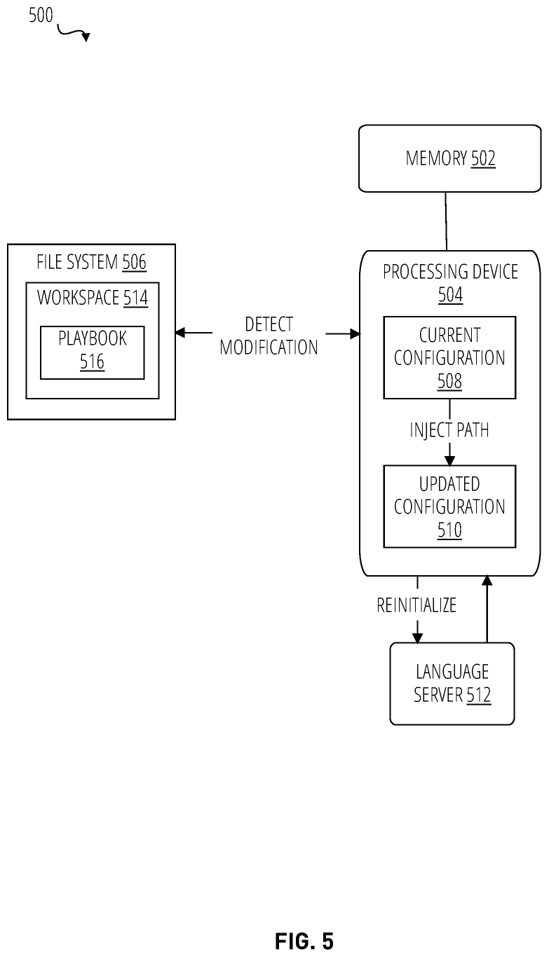

FIG. 5 illustrates a block diagram of a system 500 for supporting language features in developer environments according to some embodiments. In the illustrated embodiment, system 500 includes a memory 502, a processing device 504, a file system 506, and a language server 512. The file system 506 includes a workspace 514 with a playbook 516 It should be noted that some components of system 500 are shown for illustrative purposes only and are not physical components of the system 500, such as file system 506, workspace 514, playbook 516, current configuration 508, and updated configuration 510. One or more components of FIG. 5 may be the same or similar to one or more other components disclosed hereby. For example, processing device 504 may be the same or similar to processing device 112. Further, aspects discussed with respect to various components in FIG. 5 may be implemented by one or more other components from one or more other embodiments without departing from the scope of this disclosure. For example, language server 512 may be included in components external to system 500. Embodiments are not limited in this context.

In system 500, the processing device 504 may monitor the file system 506 for changes. In response to a modification, the processing device 504 may inject a path associated within the modification into a current configuration 508 to produce an updated configuration 510. For example, if a file is added to the workspace 514 adjacent to the playbook 516, the processing device 504 may detect the addition as a modification. In response to the modification, the processing device 504 may inject a path of the file added to the workspace 514 of file system 506 into the current configuration 508 to produce the updated configuration 510. In some embodiments, the updated configuration 510 may be stored in memory 502.

The processing device 504 may trigger the language server 512 to reinitialize based on the updated configuration 510. In some embodiments, the processing device 504 may utilize an RPC request to cause the language server 512 to reinitialize. In some such embodiments, the RPC request may include an indication of the updated configuration 510. As part of the reinitialization, the language server 512 may crawl the file system looking for relevant information. For example, the language server 512 may crawl the file system in possible locations where the core engine (e.g., Ansible™ core engine), collections, and/or roles are installed to fetch plugin documentation. As previously discussed, reinitialization of the language server 512 based on the updated configuration 510 enables the language server 512 to provide language features based on the content of playbook adjacent files in the workspace.

In some embodiments, the modification to the playbook workspace file system 506 may include the addition of a playbook adjacent file to the playbook workspace file system 506 and reinitialization of the language server 512 may enable support for one or more language features based on contents of the playbook adjacent file. In some such embodiments, the one or more language features include at least one of a go to definition feature, a hover feature, an autocompletion feature, or a validation feature. In various embodiments, when the autocompletion feature is utilized a name of a function defined in the playbook adjacent file may be identified based on user input provided during editing the playbook via the code editor and the name of the function may be presented as an autocompletion suggestion in the code editor.

In several embodiments, the modification to the playbook workspace file system 506 may include the addition of a playbook adjacent collection to the workspace and the path that corresponds to the modification to the file system may include a path of the playbook adjacent collection. In several such embodiments, the playbook adjacent collection may be created based on a namespace name, a collection name, and an initialization path and creation of the playbook adjacent collection may include scaffolding the playbook adjacent collection with one or more files in a predefined layout. Further, the playbook adjacent collection may be added to the playbook workspace file system 506. In many embodiments, the one or more files may include at least one template plugin file. In various embodiments, the playbook may be presented via a code editor (e.g., code editor 116). Further, one or more playbook task suggestions may be provided based on analysis of contents of the playbook via an AI feature (e.g., in AI resources 106) and at least one of the one or more playbook task suggestions may be presented via the code editor.

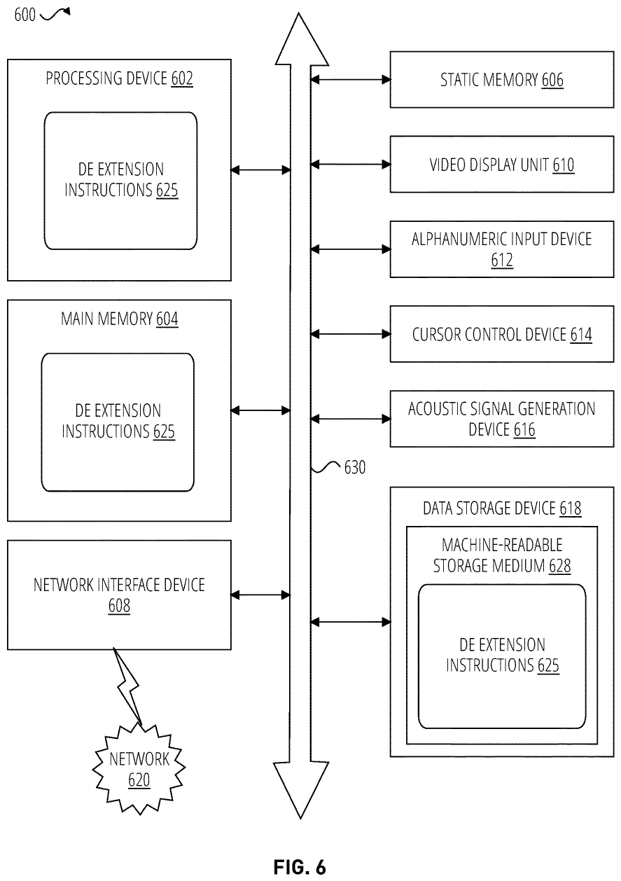

FIG. 6 is a block diagram of an example computing device 600 that may perform one or more of the operations described herein, in accordance with some embodiments of the disclosure. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device 602 (e.g., a general purpose processor, a PLD, etc.), a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), network processor, or the like. The processing device 602 may execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a machine-readable storage medium 628 on which may be stored one or more sets of instructions 625 that may include instructions for a component (e.g., one or more components of DE 108 and/or one or more components of DE extension 110) for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While machine-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “monitoring,” “detecting,” “injecting,” “triggering”, “identifying”, “presenting”, “creating”, “adding”, “determining”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combination of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
monitoring a file system of a workspace, the workspace including a playbook;
detecting a modification to the file system of the workspace;
injecting, by a processing device, a path into a current configuration associated with the playbook to produce an updated configuration associated with the playbook, wherein the path corresponds to the modification to the file system of the workspace; and
triggering a language server to reinitialize based on the updated configuration associated with the playbook.

2. The method of claim 1, wherein the modification comprises addition of a playbook adjacent file to the workspace and reinitialization of the language server enables support for one or more language features based on contents of the playbook adjacent file.

3. The method of claim 2, wherein the one or more language features comprise at least one of a go to definition feature, a hover feature, an autocompletion feature, or a validation feature.

4. The method of claim 3, wherein the one or more language features comprise the autocompletion feature and the method further comprises:
identifying a name of a function defined in the playbook adjacent file utilizing the autocompletion feature, the name of the function identified based on user input provided during editing the playbook via a code editor; and
presenting the name of the function as an autocompletion suggestion in the code editor.

5. The method of claim 1, wherein the modification comprises addition of a playbook adjacent collection to the workspace and the path that corresponds to the modification to the file system comprises a path of the playbook adjacent collection.

6. The method of claim 5, further comprising:
creating the playbook adjacent collection based on a namespace name, a collection name, and an initialization path, wherein creation of the playbook adjacent collection includes scaffolding the playbook adjacent collection with one or more files in a predefined layout; and
adding the playbook adjacent collection to the workspace.

7. The method of claim 6, wherein the one or more files comprise at least one template plugin file.

8. The method of claim 1, further comprising:
presenting the playbook via a code editor;
determining one or more playbook task suggestions based on analysis of contents of the playbook via an artificial intelligence (AI) feature; and
presenting at least one of the one or more playbook task suggestions via the code editor.

9. A system comprising:
a memory; and
a processing device, operatively coupled to the memory, to:
monitor a file system of a workspace, the workspace including a playbook;
detect a modification to the file system of the workspace;
inject a path into a current configuration associated with the playbook to produce an updated configuration associated with the playbook, wherein the path corresponds to the modification to the file system of the workspace; and
trigger a language server to reinitialize based on the updated configuration associated with the playbook.

10. The system of claim 9, wherein the modification comprises addition of a playbook adjacent file to the workspace and reinitialization of the language server enables support for one or more language features based on contents of the playbook adjacent file.

11. The system of claim 10, wherein the one or more language features comprise an autocompletion feature and the processing device is further to:
identify a name of a function defined in the playbook adjacent file utilizing the autocompletion feature, the name of the function identified based on user input provided during editing the playbook via a code editor; and
present the name of the function as an autocompletion suggestion in the code editor.

12. The system of claim 9, wherein the modification comprises addition of a playbook adjacent collection to the workspace and the path that corresponds to the modification to the file system comprises a path of the playbook adjacent collection.

13. The system of claim 12, wherein the processing device is further to:
create the playbook adjacent collection based on a namespace name, a collection name, and an initialization path, wherein creation of the playbook adjacent collection includes scaffolding the playbook adjacent collection with one or more files in a predefined layout; and
add the playbook adjacent collection to the workspace.

14. The system of claim 13, wherein the one or more files comprise at least one template plugin file.

15. The system of claim 9, wherein the processing device is further to:
present the playbook via a code editor;
determine one or more playbook task suggestions based on analysis of contents of the playbook via an artificial intelligence (AI) feature; and
present at least one of the one or more playbook task suggestions via the code editor.

16. A non-transitory computer-readable storage medium including instructions that, when executed by a processing device, cause the processing device to:
monitor a file system of a workspace, the workspace including a playbook;
detect a modification to the file system of the workspace;
inject, by the processing device, a path into a current configuration associated with the playbook to produce an updated configuration associated with the playbook, wherein the path corresponds to the modification to the file system of the workspace; and
trigger a language server to reinitialize based on the updated configuration associated with the playbook.

17. The non-transitory computer-readable storage medium of claim 16, wherein the modification comprises addition of a playbook adjacent file to the workspace and reinitialization of the language server enables support for one or more language features based on contents of the playbook adjacent file.

18. The non-transitory computer-readable storage medium of claim 17, wherein the one or more language features comprise an autocompletion feature and the processing device is further to:
identify a name of a function defined in the playbook adjacent file utilizing the autocompletion feature, the name of the function identified based on user input provided during editing the playbook via a code editor; and
present the name of the function as an autocompletion suggestion in the code editor.

19. The non-transitory computer-readable storage medium of claim 16, wherein the modification comprises addition of a playbook adjacent collection to the workspace, the path that corresponds to the modification to the file system comprises a path of the playbook adjacent collection, and the processing device is further to:
create the playbook adjacent collection based on a namespace name, a collection name, and an initialization path, wherein creation of the playbook adjacent collection includes scaffolding the playbook adjacent collection with one or more files in a predefined layout; and
add the playbook adjacent collection to the workspace.

20. The non-transitory computer-readable storage medium of claim 16, wherein the processing device is further to:
present the playbook via a code editor;
determine one or more playbook task suggestions based on analysis of contents of the playbook via an artificial intelligence (AI) feature; and
present at least one of the one or more playbook task suggestions via the code editor.
